(19) United States
(12) Patent Application Publication
(10) Pub. No.: US 2007/0243010 A1
(43) Pub. Date: Oct. 18, 2007

(54) Multi-color pen having storage function

(76) Inventor: Hsiao-Chi Lin, Taipei City (TW)

Correspondence Address: TROXELL LAW OFFICE PLLC, SUITE 1404, 5205 LEESBURG PIKE, FALLS CHURCH, VA, 22041, US

(21) Appl. No.: 11/403,891

(22) Filed: Apr. 14, 2006

(51) Int. Cl. B43K 29/00; B43K 27/00

(52) U.S. Cl. 401/195; 401/29

(57) ABSTRACT

A multi-color pen having storage function including a hollow pen holder, a pen stand disposed inside an end of the pen holder, and refills in at least two different colors containing inside the pen stand. An elastic member is sleeved on each refill, elastically retracting a nib of the refill that is protruded outside the pen holder into the pen holder. A storage device, which is disposed on another end of the pen holder corresponding to the pen stand, is formed by a housing having a circuit board as well as a USB connector, which protrudes outside the pen holder and is covered by a pen lid that can be joined to and separated from the pen holder, and providing refills in different colors for writing purposes and also providing a storage device for data storage and forming a multi-color pen having storage function.

### BACKGROUND OF THE INVENTION

(a) Field of the Invention

The present invention relates to a multi-color pen having storage function, more particularly, to a multi-color pen having refills in more than two different colors as well as storage function.

(b) Description of the Prior Art

Pens are very convenient and include fountain pens, Chinese writing brushes, pencils, automatic pencils, ball-point pens, multi-color pens, color pens, etc., for writing in different writing styles. Among them, the multi-color pen primarily comprises a hollow pen barrel, an elastic clipping component, and a refill barrel disposed inside the hollow pen barrel for holding refills. A space is provided between an exterior of the refill barrel and an inner wall of the pen barrel for holding a plurality of color refills. A clipping member having a spring is then provided at a tip of a head of the pen barrel relative to the refill barrel for fixing and pushing refills, and a pressing member, which is an assemblage member disposed at an end of the refill barrel for sealing the end of the refill barrel and pressing the refill barrel. A lid body is provided on the pressing member to hold refills inside the pen barrel, thereby forming a multi-color pen having variegated changes in one pen.

In the past, if users wanted to transfer data to another computer, they were required to copy the data first onto a diskette or a CD ROM and then insert the diskette or CD ROM into another computer in order to store the data inside.

However, with progress in computer technology, the development of a USB (Universal Serial Bus) flash drive has replaced the aforementioned data storage method. The USB flash drive adopts a plug-and-play USB interface and has the advantages of a very large memory and a higher access speed than floppy diskettes. Only a USB connector of the flash drive is required to be inserted into a USB port of the computer for reading and storing information.

Despite this, the aforementioned multi-color pen or USB flash drive comprises only one function. For example, the multi-color pen has only the multi-color function whereas the USB flash drive has only the data storage function. As a result, the problem to be solved by those who are familiar with the prior art is how to integrate both functions.

### SUMMARY OF THE INVENTION

It is the primary object of the present invention to provide a multi-color pen having storage function. The multi-color pen comprises a hollow pen holder, refills in at least two different colors, a pen stand, a storage device, and a pen lid, wherein an external diameter at an end of the pen holder tapers off into a pen hole that allows the passing of only one refill, and another end of the pen holder is provided with an opening. The pen stand is installed inside an end of the pen holder and contains refills in at least two different colors. An elastic member is sleeved on each refill, elastically retracting a nib of the refill that is protruded outside the pen hole into the pen holder. The storage device is formed by a housing having a circuit board as well as a USB connector. The housing is fixed inside the pen holder and the USB connector protrudes from an opening of the pen holder and is covered by a pen lid that can be joined to and separated from the pen holder.

In summary, the multi-color pen of the present invention provides refills in different colors for writing purposes and also provides a storage device for data storage, thereby forming a multi-color pen having storage function.

To enable a further understanding of the objectives and the technological methods of the invention herein, the brief description of the drawings below is followed by the detailed description of the preferred embodiments.

### BRIEF DESCRIPTION OF THE DRAWINGS

FIG. 1 shows an exploded perspective view of the multi-color pen according to the present invention.

FIG. 2 shows a combinatorial perspective view of the multi-color pen according to the present invention.

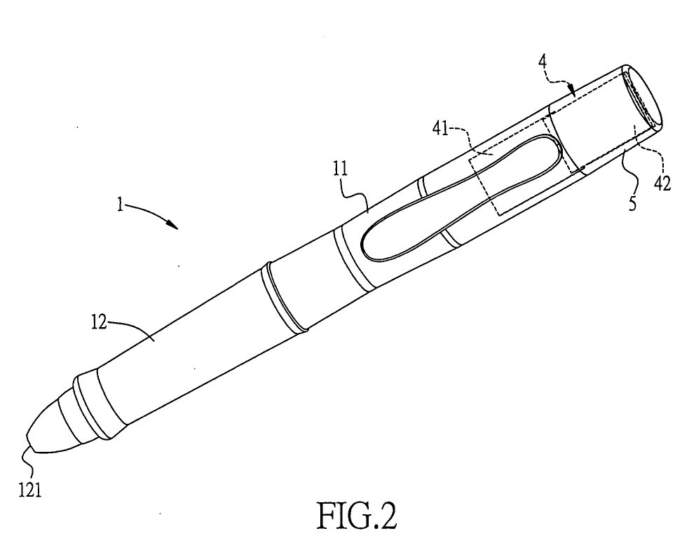

FIG. 3 shows an external perspective view of the multi-color pen protruded from the USB connector according to the present invention.

### DETAILED DESCRIPTION OF THE PREFERRED EMBODIMENTS

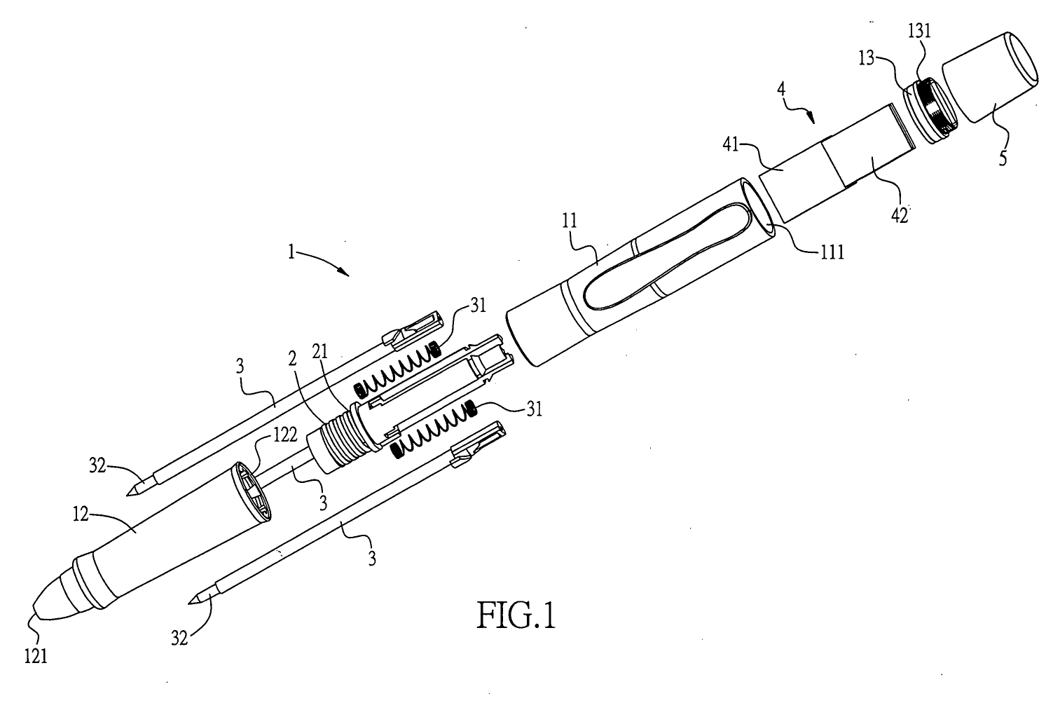

Referring to FIG. 1, the present invention provides a multi-color pen, comprising a hollow pen holder 1, a pen stand 2, refills 3 in at least two different colors, a storage device 4, and a pen lid 5.

The pen holder 1 comprises an upper pen barrel 11 and a lower pen barrel 12. An external diameter at an end of the lower pen barrel 12 tapers off into a pen hole 121 that can allow the passing of only one refill 3, whereas a lower inner thread 122 is formed on an inner sidewall at another end of the lower pen barrel 12. The pen stand 2 is fixed inside an end of the upper pen barrel 11 and another end of the upper pen barrel 11 is provided with an opening 111. The pen stand 2 contains refills 3 in at least two different colors. The present embodiment is provided with refills 3 in three different colors, having a spring 31 sleeved on each of the refills 3, and elastically retracting a nib 32 of the refill 3 that is protruded outside the pen hole 121 into the lower pen barrel 12, whereas a lower outer thread 21 that screws together with the lower inner thread 122 of the lower pen barrel 12 is disposed on an end of the pen stand 2 that protrudes outside the upper pen barrel 11.

Referring to FIG. 1, the storage device 4 of the present invention is formed by a housing 41 having a circuit board as well as a USB connector 42. The housing 41 is fixed inside the upper pen barrel 11 and the USB connector 42 protrudes outside an opening 111 of the upper pen barrel 11. A hollow sleeve 13, provided with an upper outer thread 131 on an end thereof, is tightly sleeved on the opening 111 of the upper pen barrel 11. The USB connector 42 is provided with a pen lid 5 capable of sleeving and concealing the USB connector 42, and an inner wall surface of the pen lid 5 is provided with an upper inner thread 132 (not shown in the diagram) that can work together with the upper outer thread 131 of the sleeve 13.

During assembling, refills 3 in three different colors, each of which is sleeved with a spring 31, are contained inside the pen stand 2. Then the pen stand 2 and a part of the refills 3 are sleeved inside the upper pen barrel 11. The housing 41 of the storage device 4 is inserted into the upper pen barrel 11, and the sleeve 13 is fixed on the opening 111 at an end of the upper pen barrel 11, such that the USB connector 42 passes through the sleeve 13 and protrudes outside the upper pen barrel 11. Then an end of the pen stand 2 having the lower outer thread 21 and an end of the refill 3 having a nib 32 are inserted into the lower pen barrel 12. The upper pen barrel 11 is rotated, such that the lower outer thread 21 of the pen stand 2 is screwed together with the lower inner thread 122 at the inner sidewall at the end of the lower pen barrel 12, thereby joining the upper pen barrel 11 and the lower pen barrel 12. Finally, the pen lid 5 is covered on the USB connector 42 and is tightly rotated, such that the upper inner thread 132 at an inner sidewall of the pen lid 5 is screwed together with the upper outer thread 131 of the sleeve 13, making the pen lid 5 being tightly covered on the upper pen barrel 11.

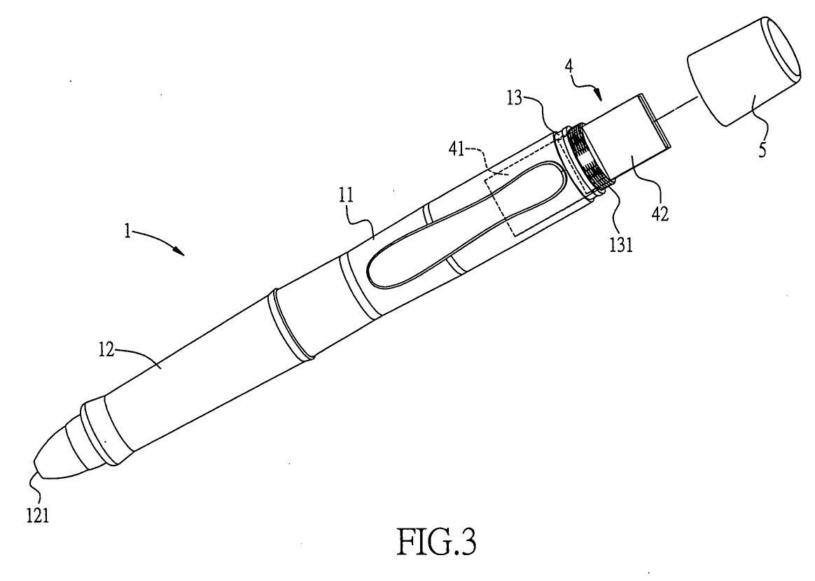

Referring to FIG. 3, when the user wants to use the multi-color pen for data storage, the pen lid 5 is rotated until it is loosened and discharged, exposing the USB connector 42, which is then inserted into a USB port of a to-be-data stored electronic equipment, such that data can be read and stored using the plug-and-play property of the USB connector 42.

In summary, the multi-color pen of the present invention is provided with refills 3 in different colors for writing purposes and is also provided with the storage device 4 for data storage function, thereby forming a multi-color pen having storage function.

It is of course to be understood that the embodiment described herein is merely illustrative of the principles of the invention and that a wide variety of modifications thereto may be effected by persons skilled in the art without departing from the spirit and scope of the invention as set forth in the following claims.

1-3. (canceled)

4. A multi-color pen having a storage function comprising:
a) a pen holder being hollow and having:
i) a pen hole located on a first end thereof, the pen hole is formed by an external diameter of the hollow pen holder tapering at the first end and forming the pen hole; and
ii) a pen holder opening located in a second end thereof and having a diameter larger than a diameter of the pen hole;
b) a pen stand located in an interior of the pen holder and having at least two refills, the pen stand elastically retracting a nib of each of the at least two refills into the pen holder;
c) a storage device having a housing having a circuit board and a USB connector, the housing of the storage device is fixed in the interior of the pen holder, the USB connector protruding outwardly from the pen holder opening; and
d) a pen lid removably connected to the pen holder and selectively covering USB connector,
wherein the pen stand having the at least two refills is located between the pen hole and the USB connector.

5. The multi-color pen according to claim 4, wherein the pen holder includes a lower pen barrel and an upper pen barrel, the pen hole is located in a first end of the lower pen barrel, the pen stand is connected to a first end of the upper pen barrel, a second end of the lower pen barrel is threadedly connected to the pen stand, the pen holder opening is located in a second end of the upper pen barrel.

6. The multi-color pen according to claim 4, further comprising a hollow sleeve connected to the pen holder opening of the pen holder, the pen lid is threadedly connected to the hollow sleeve.

7. The multi-color pen according to claim 4, wherein the at least two refills are different colors.
